(19) United States
(12) Patent Application Publication
(10) Pub. No.: US 2009/0310806 A1
(43) Pub. Date: Dec. 17, 2009

(54) Hearing Device with a Battery Compartment to Accommodate a Battery Secured by a Spring Element

(76) Inventors: Werner Fickweiler, Bubenreuth (DE); Tom Weidner, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/485,425

(22) Filed: Jun. 16, 2009

(30) Foreign Application Priority Data
Jun. 17, 2008 (DE) 10 2008 028 421.1

(51) Int. Cl. H04R 25/00

(52) U.S. Cl. 381/323

(57) ABSTRACT

A battery compartment has a spring element for securing a battery in the battery compartment where the spring element is secured in the battery compartment in such a way that it can be replaced, for example upon slackening of the spring tension. According to one embodiment of the invention, the nature of the spring element additionally identifies the setting or the function of the hearing device

### CROSS REFERENCE TO RELATED APPLICATIONS

This application claims priority of German application No. 10 2008 028 421.1 DE filed Jun. 17, 2008, which is incorporated by reference herein in its entirety.

### FIELD OF INVENTION

The invention relates to a hearing device with a battery compartment, having a spring element for securing a battery accommodated in the compartment.

### SUMMARY OF INVENTION

A hearing device is operated by a battery, which is accommodated in a battery compartment. It is known that batteries are secured in the battery compartment in friction-fitted form by means of a spring element permanently connected with the battery compartment. As the spring element is generally made of plastic, the spring tension diminishes in the course of time and particularly in the case of frequent changing of the battery, so that the battery is no longer securely held in the battery compartment.

The object of the invention is thus to create a hearing device that enables secure holding of the battery in the battery compartment even over a lengthy period and/or in the case of frequent changing of the battery.

The object is achieved by means of a hearing device according to the independent claims; advantageous embodiments are the subject of the related subclaims.

Through the exchangeable means of securing of the spring element in the battery compartment it is possible to change the spring element in a simple manner in the case of slackening spring tension. In this way, the effort of replacing the entire battery compartment, as previously necessary in the case of customary battery compartments with a permanently connected spring element, is avoided.

Furthermore, the replaceable nature of the spring element thus opens up the possibility of using the spring element to indicate, for example, the setting of the hearing device and/or its functions. If the settings and/or the functions of the hearing device are changed, this can be indicated through changing of the spring element. Separate marking of the device, as customary with traditional hearing devices, is thus redundant.

### BRIEF DESCRIPTION OF THE DRAWINGS

In the following detailed description of the figures, exemplary embodiments which are not to be regarded as restrictive are discussed, together with their features and further advantages on the basis of the diagrammatic drawings. These representations are in three-dimensional form, wherein:

FIG. 1 shows a hearing device with a battery compartment;

FIG. 2-4 shows the insertion of a battery into the battery compartment according to FIG. 1;

FIG. 5 shows part of a hearing device with a battery compartment having a replaceable spring element, viewed at an angle from below;

FIG. 6 shows the hearing device according to FIG. 5 viewed at an angle from above;

FIG. 7 shows a red spring element for the battery compartment according to FIGS. 5 and 6;

FIG. 8 shows the spring element according to FIG. 7 in a blue embodiment;

FIG. 9 shows part of a further hearing device with a battery compartment having a replaceable spring element, viewed at an angle from above;

FIG. 10 shows a red spring element for the battery compartment according to FIG. 9;

FIG. 11 shows the spring element according to FIG. 10 in a blue embodiment.

### DETAILED DESCRIPTION OF INVENTION

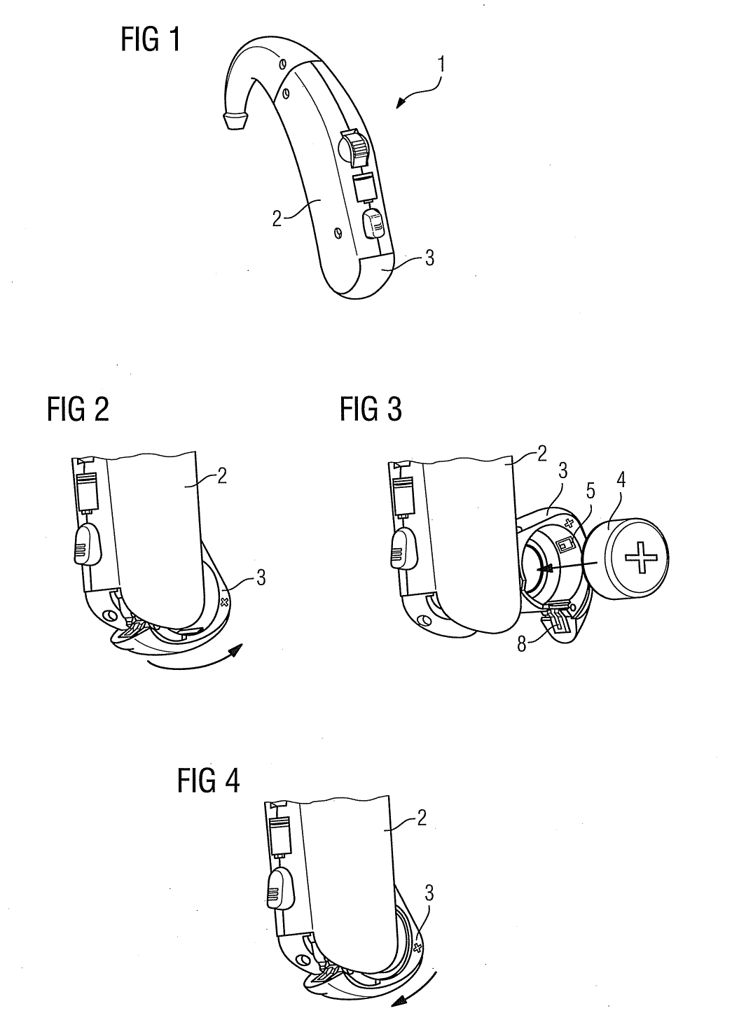

FIG. 1 shows a hearing device 1 with a housing 2 and a battery compartment 3. The battery compartment 3 is represented in a closed state.

The FIGS. 2-4 show opening of the battery compartment 3, insertion of a battery 4 into the battery compartment and closing of the battery compartment 3 in that order.

The nature of the hearing devices 1 and the mechanism for opening and closing the battery compartment 3 as shown are known from the prior art. The battery compartment 3 differs from the prior art in the nature of the spring element 5 represented in FIG. 3, which is secured in the battery compartment 3 in replaceable form.

The battery is pressed against the side wall of the battery compartment 3 lying opposite the spring element 5 by the spring tension of the spring element 5. By means of the friction-fitted securing of the battery 4 in the battery compartment 3 by the spring element 5, the battery can also be changed simply without the need for a special tool while otherwise being held securely in place. As, when ready for operation, the battery compartment 3 folds into the housing 2 of the hearing device 1, the battery 4 is additionally protected against falling out of the battery compartment 3.

Further details of this battery compartment 3 and the spring element 5 are explained with reference to the following Figures.

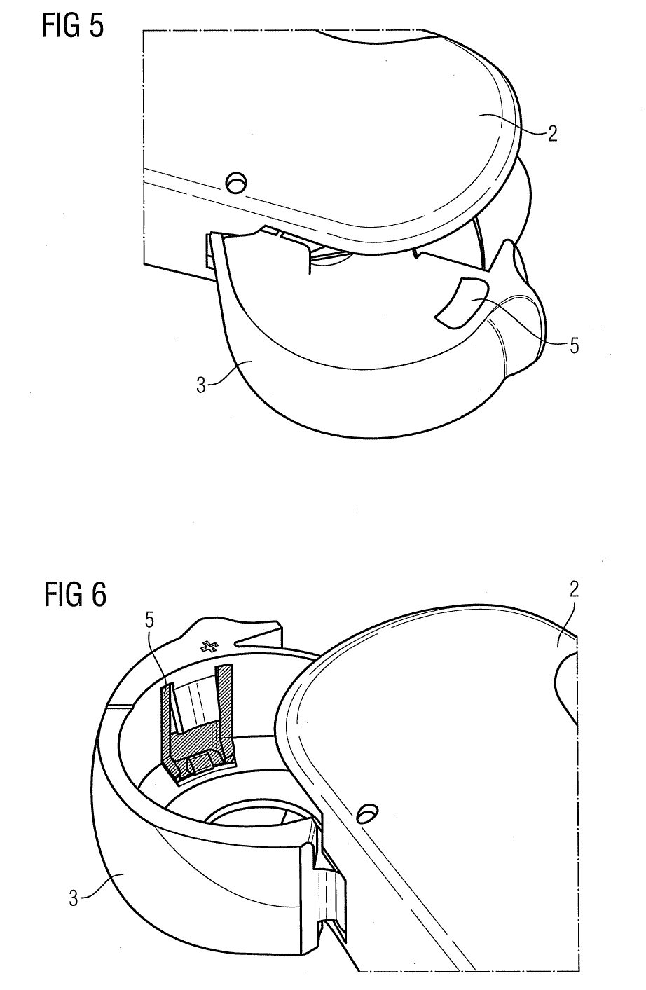

FIGS. 5 and 6 in each case show enlarged sectional views of the battery compartment 3; FIG. 5 is seen at an angle from below and FIG. 6 at an angle from above.

In this exemplary embodiment, the spring element 5 can be cost-effectively manufactured from plastic. Even if over the course of time, the spring tension of the spring element 5 loses spring tension, e.g. as a result of the repeated insertion of a new battery, no repair effort is necessary, as the spring element 5 can be replaced in a simple manner.

It is also possible to manufacture the spring element 5 of metal, which is less prone to wear than plastic. Such a spring element 5 therefore needs less frequent replacement than one made of plastic. A spring element 5 made partly of plastic and partly of metal can also be used.

The external appearance of the spring element 5 differentiates the hearing device 1 from others, so that the risk of confusion is reduced. The external appearance of the spring element 5 preferably enables the setting and/or the functions of the hearing device 1 to be distinguished from other hearing devices. The spring element 5 can, for example, indicate for which side of the wearer's head the hearing device 1 is adapted. In the case of conventional hearing devices, such characteristics are indicated by an additional right/left indication of the device.

The dual function of the spring element 5 for securing the battery 4 on the one hand and for identifying the hearing device 1 achieves a particularly synergetic effect, which is especially advantageous because of the small dimensions of a hearing device.

In the present example, the spring element 5 is simply identified by its red color. In the case of parts manufactured in plastic the color is particularly simple to change without needing to adapt the mold for the plastic part.

Alternatively or in addition, the spring element 5 is also identified by means of its shape or surface structure. This has the advantage that the spring element 5 and thereby the hearing device 1 can be distinguished by touch.

In the exemplary embodiment represented, the spring element 5 is secured in a guide in the battery compartment 3. In FIG. 5, the spring element 5 is visible in the lower opening of the guide, so that the identification conveyed by the spring element 5 continues to be visible when a battery 4 is inserted in the battery compartment 3.

The guide is arranged on the battery compartment 3 such that the lower opening of the guide discernible in FIG. 5 is covered by the housing 2 of the hearing device. The spring element 5 secured in the guide is thereby additionally protected from falling out, from soiling or from wear during normal operation of the hearing device 1. In addition, covering of the identification serves an esthetic purpose.

By means of a viewing window (not shown) in the housing 2, through which the spring element 5 is also visible even with the battery compartment 3 in its closed state, the spring element still performs its identification function with the hearing device 1 in a state of operational readiness.

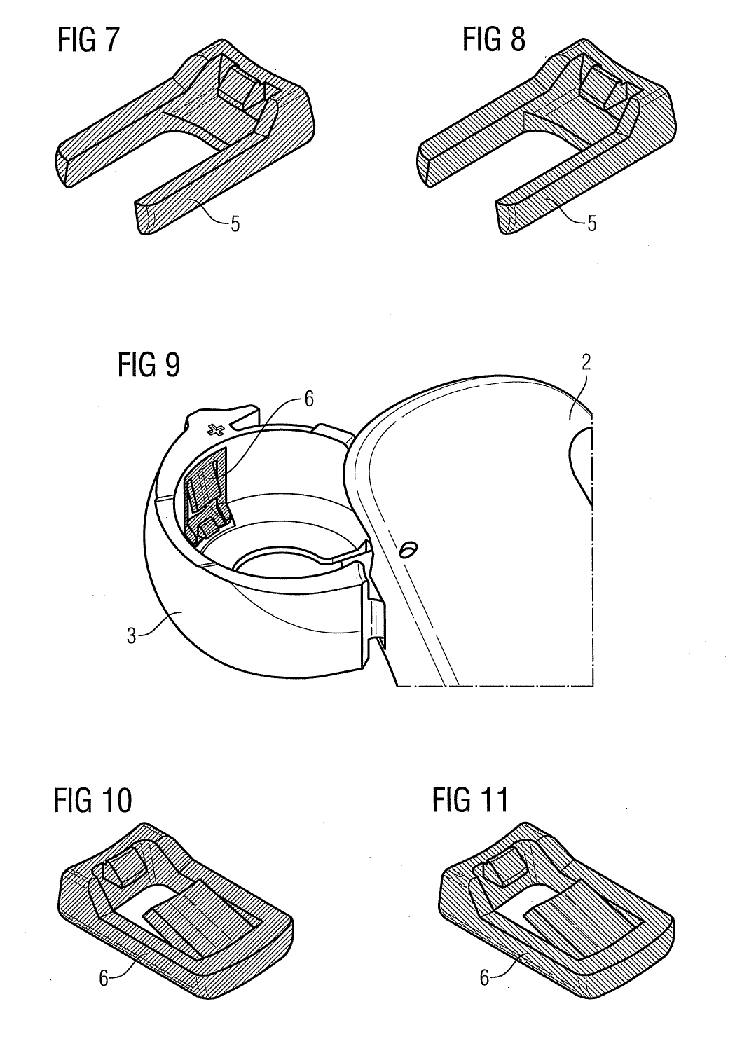

FIGS. 7 and 8 show an embodiment of the spring element 5 in enlarged form. Externally, the spring elements 5 are differentiated solely through their color; the spring element 5 in FIG. 7 is red, whereas the spring element 5 in FIG. 8 is blue.

FIG. 9 shows a further battery compartment 3 of a hearing device 1 with a spring element 6 which differs in shape from that represented in FIGS. 5-8.

FIGS. 10 and 11 show spring element 6 depicted in FIG. 9 in enlarged form. As in FIGS. 7 and 8, the spring elements are differentiated by their color; the spring element 6 in FIG. 10 is red and the spring element 6 in FIG. 11 is blue.

In summary, one embodiment of the invention comprises a hearing device 1 with a battery compartment 3, having a spring element 5 or 6 for securing a battery 4 in the battery compartment 3, where the spring element 5 or 6 is secured in the battery compartment 3 in such a way that it can, for example, be replaced upon slackening of the spring tension. According to one embodiment of the invention, the nature of the spring element 5 additionally identifies the setting or the function of the hearing device 1.

1.-12. (canceled)

13. A hearing device, comprising:
a battery compartment having a spring element that secures a battery in the battery compartment, the spring element is secured in the battery compartment in a replaceable manner.

14. The hearing device as claimed in claim 13, wherein the spring element secures the battery in a friction-fitted manner.

15. The hearing device as claimed in claim 13, wherein the spring element is manufactured from plastic.

16. The hearing device as claimed in claim 13, wherein the spring element is manufactured from metal.

17. The hearing device as claimed in claim 14, wherein the spring element is manufactured from plastic.

18. The hearing device as claimed in claim 14, wherein the spring element is manufactured from metal.

19. The hearing device as claimed in claim 13, wherein the battery compartment has a guide in which the spring element is secured in a friction-fitted manner.

20. The hearing device as claimed in claim 13, wherein an external appearance of the spring element distinguishes the hearing device from another hearing device.

21. The hearing device as claimed in claim 20, wherein the external appearance identifies a setting of the hearing device.

22. The hearing device as claimed in claim 20, wherein the external appearance identifies the functions of the hearing device.

23. The hearing device as claimed in claim 20, wherein the external appearance is determined by a color of the spring element.

24. The hearing device as claimed in claim 20, wherein the spring element is secured in the battery compartment such that the external appearance is recognizable while the battery is secured in the battery compartment.

25. The hearing device as claimed in claim 13, wherein the spring element is covered by the housing of the hearing device when the battery compartment is closed.

26. The hearing device as claimed in claim 25, wherein the spring element is covered by the housing of the hearing device when the battery compartment is closed.

27. The hearing device as claimed in claim 26, wherein the housing of the hearing devices has a transparent window, through which the external appearance of the spring element is recognizable when the battery compartment is closed.
